(19) United States
(12) Patent Application Publication
(10) Pub. No.: US 2023/0271202 A1
(43) Pub. Date: Aug. 31, 2023

(54) FLUID RESERVOIR FOR A SPRAY GUN WITH A VENTILATION DEVICE

(71) Applicant: SATA GmbH & Co. KG, Kornwestheim (DE)

(72) Inventor: Peter DETTLAFF, Remseck (DE)

(73) Assignee: SATA GmbH & Co. KG, Kornwestheim (DE)

(21) Appl. No.: 18/017,910

(22) PCT Filed: Jul. 29, 2021
(86) PCT No.: PCT/EP2021/071252

§ 371 Date: Jan. 25, 2023

(30) Foreign Application Priority Data
Jul. 31, 2020 (DE) 10 2020 120 229.6

(51) Int. Cl. B05B 7/24

(52) U.S. Cl. CPC B05B 7/2408; B05B 7/2478

(57) ABSTRACT

A fluid reservoir for a spray gun, which fluid reservoir has a material outlet which is configured for the direct and/or indirect connection to a spray gun. The fluid reservoir includes a material container which is closed at least at one end face by a disk-shaped closing wall. A ventilation device is arranged on the outside of the closing wall. Advantageously, the closing wall is provided with a concavity which uniformly extends over the closing wall.

### FIELD OF THE INVENTION

The invention relates to a flow cup for a spray gun, which has a material outlet embodied for direct and/or indirect connection to a spray gun, the flow cup having a material container which on at least one end side is closed by a disk-shaped end wall, a ventilation device by way of which air can flow into the flow cup to enable pressure equalization when material flows out of the flow cup by way of the material outlet being disposed on the outside of the end wall.

### BACKGROUND

A flow cup of this type is known, for example, from DE 10 2004 007 733 A1. The flow cup described therein comprises a cup-shaped container and a cover that can be screwed onto the latter via a thread. The cover, on the upper side thereof, has an outlet port with an outlet opening, which is configured for direct or indirect (by means of an adapter) connection to a spray gun. In order to guarantee pressure equalization when material flows out of the flow cup by way of the outlet port, a ventilation valve is provided on the outside of the base of the cup-shaped container, which forms a disk-shaped end wall of the container.

Even if flow cups, depending on the embodiment, can be reused relatively often, they are consumables that are consumed in large numbers in a normal paint shop. The procurement costs of said flow cups consequently play an economic role and are determined to a significant extent by the transport and storage costs of the flow cup, which in turn are influenced by the space required by the individual flow cup for storage and transport.

Known from US 2019/126300 A is a flow cup of which the ventilation valve is offset inward and received in a centric depression in the base of the material container. The space requirement of the material container is reduced by this measure. It is disadvantageous, however, that the ventilation valve disposed in the depression is difficult to access from the outside.

### SUMMARY OF THE INVENTION

One aspect of the invention therefore relates to reducing the space requirement of the generic flow cup without any compromises in terms of handling or functionality.

Accordingly, various embodiments of a flow cup are disclosed herein.

According to the invention, the end wall of the material container, on the outside of which the ventilation device is disposed, is provided with a concavity which extends uniformly across the end wall. In particular, this is a concave curvature toward the interior of the material container.

Thanks to the uniform concavity, the ventilation device axially projects to a lesser extent in relation to the peripheral region of the end wall, as a result of which the space required by the material container is reduced. At the same time, the ventilation device is still readily accessible from the outside. The defined inward curvature of the end wall moreover ensures that a disadvantageous convex curvature of the end wall, e.g. caused by the injection molding process, is reliably ruled out.

It goes without saying that the concavity is present in the basic state of the material container and not only when a force is applied to the end wall, e.g. as a result of internal pressure or the like.

The disk-shaped end base, optionally conjointly with further components of the flow cup, is preferably produced from plastics material in a plastics injection-molding method. The concavity is generated by a correspondingly curved cavity in the injection-molding tool.

The curved end wall can also be advantageous for the injection-molding process. In this way, the curvature by way of a favorable selection of the injection point can thus bring about or support centering of the injection-molding tools relative to one another when the mold cavity is filled with highly pressurized liquid plastics material.

In practice, an embodiment of the invention in which the location of the concave end wall, which protrudes furthest inward due to the concavity, in relation to the outer peripheral region of the end wall has an offset or a depth of 1% to 4%, preferably of 1.5% to 3% of the diameter of the end wall, has proven successful. The relatively slight concavity results in the desired effect of a reduced space requirement, the stability and manufacturability of the flow cup not being adversely affected at the same time.

In preferred exemplary embodiments, the concave end wall is embodied so as to be circular, having a defined diameter. In alternative exemplary embodiments, the shape of the end wall can also deviate from a circular shape and be elliptical or rectangular, for example. In this case, the maximum width is to be considered the diameter for determining the preferred manifestation of the concavity described above.

In the case of a particularly preferred exemplary embodiment, the ventilation device comprises an off-center ventilation opening through the concave end wall, which is disposed with an offset relative to the center of the end wall, which is preferably more than 5% and less than 10% of the diameter of the end wall. In this way, the ventilation device is disposed at least almost centrically on the end wall, but due to the eccentric arrangement of the ventilation opening, the injection point can nevertheless be chosen to be ideally centric when producing the end wall in an injection-molding process.

A preferred exemplary embodiment is distinguished by good accessibility of the corner region between the end base and an attached circumferential wall of the flow cup, in that the concave end wall adjoins the circumferential wall of the flow cup at an angle of more than 90°. However, the angle is preferably less than 95°.

The concave end wall and the circumferential wall enclose an angle of more than 90° and preferably less than 95°.

For the same reason, the curved end wall preferably transitions to the circumferential wall with a relatively large radius of curvature.

The circumferential wall of the flow cup, proceeding from the end side that is closed by the concave end wall, preferably widens conically. Thanks to the conical configuration, the component of the flow cup that is closed by the end wall can be stacked with other similar components, which enormously reduces the space required for the individual component during transport.

Particularly preferred is a variant in which the conicity additionally results in the concave end wall adjoining the circumferential wall at an angle of more than 90°, or the concave end wall and the circumferential wall enclosing an angle of more than 90° and preferably less than 95°, respectively.

In the case of a preferred variant, a circumferential periphery is provided which projects outward in relation to the concave end wall. The circumferential periphery can serve to hold back any material that may potentially escape via the ventilation device. Depending on the design of the flow cup, the circumferential periphery can also serve as a standing edge for the component of the flow cup that is provided with the concave end wall.

Due to their functional reliability and robustness when used in the painting sector, mechanically activatable ventilation devices have proven successful. A variant of the invention in which the ventilation device comprises a closure element which can be moved between an open position, in which air can flow into the flow cup, and a closed position, in which no air can flow through the ventilation device into the flow cup, is therefore preferred. The closure element is preferably moved between the open position and the closed position along the longitudinal axis of the flow cup or transversely to the curved end wall.

The movable closure element of the ventilation device in the closed position is preferably set back in relation to the circumferential periphery and/or in the open position projects in relation to the circumferential periphery.

In a particularly preferred exemplary embodiment, the concave end wall is releasably connected to the material container.

The concave end wall is preferably part of a cover of the flow cup. In addition, the material outlet, in particular in the form of an outlet port, can be provided on the side of the material container opposite the cover. In this case, the flow cup according to the invention is embodied as a standard flow cup.

Alternatively, the flow cup according to the invention can be embodied as an upside-down flow cup. The concave end wall forms the base of a cup-shaped material container. The material outlet, in particular in the form of an outlet port, is molded on a removable cover of the flow cup. The concave end wall is preferably produced from plastics material, so as to be integral to the tubular, in particular slightly conical, container wall, in an injection-molding method.

The material container is embodied in particular in such a manner that a plurality of material containers can be stacked one inside the other, preferably with an protrusion of less than 20%, preferably less than 15%, more preferably less than 10% of the total height of the individual material container.

In the material container with a uniformly concave base, materials, for example a paint made up of several components, can be mixed unhindered and completely. The inside of the concave end wall preferably forms a flat or smooth surface, in particular when the ventilation device is closed.

As already mentioned, the cover and the material container are preferably made from plastics material in an injection-molding method. It is particularly advantageous if the cover and/or the material container are produced as integral plastic injection-molded parts. It goes without saying that the cover and the material container are also to be regarded as an integrally produced component if individual smaller components are produced separately. For example, it has proven successful in practice not to manufacture sieve elements, (movable) valve bodies, caps, etc. so as to be integral to the cover or the material container. However, this is entirely conceivable and technically feasible.

The flow cup according to the invention is preferably an extremely thin-walled product. Thus, the wall thickness of the material container is in the range from 0.55 mm to 0.65 mm, for example, preferably 0.60 mm, and/or the wall thickness of the cover is in the range from 0.75 mm to 0.85 mm, for example, preferably 0.80 mm.

### BRIEF DESCRIPTION OF THE DRAWINGS

The invention will be explained hereunder by means of exemplary embodiments. In the figures:

FIG. 1 shows a sectional view of a spray gun with a flow cup according to a first exemplary embodiment of the invention;

FIG. 2 shows a partial sectional view of the flow cup according to FIGS. 1 and 9 in the region of the connection between the cover and the material container of the flow cup;

FIGS. 3 to 5 show partial sectional views of the flow cup according to FIGS. 1 and 9 in the region of the ventilation system in three different states;

FIGS. 6 and 7 show a perspective and a lateral view of the closure element of the ventilation device of the flow cup according to FIGS. 1 and 9;

FIG. 8 shows a perspective view of an alternative embodiment of the closure element of the ventilation device of the flow cup according to FIGS. 1 and 9;

FIG. 9 shows a sectional view of a flow cup according to a second embodiment of the invention;

FIGS. 10 and 11 show a perspective and a sectional view of the cover of the flow cup according to FIG. 9;

FIG. 12 shows a perspective view of the material container of the flow cup according to FIG. 9; and

FIGS. 13 and 14 show a perspective view and a top view of an alternative embodiment of the closure element of the ventilation device of the flow cup according to FIGS. 1 and 9.

### DETAILED DESCRIPTION

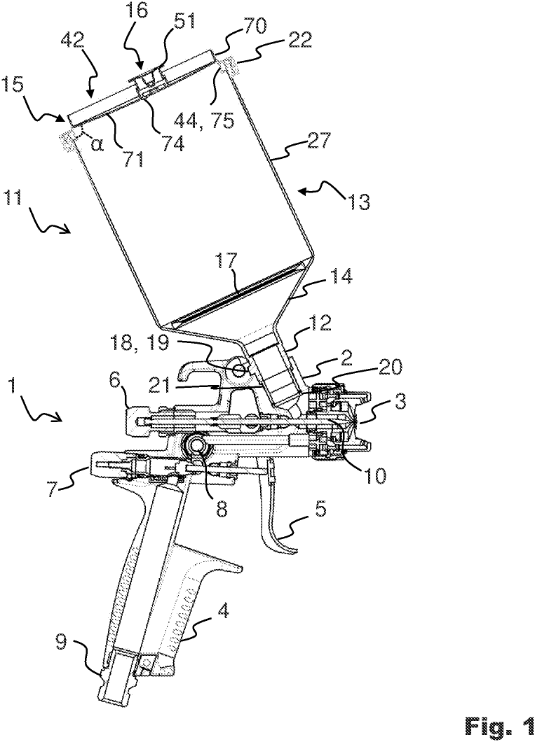

FIG. 1 shows a hand-held spray gun 1 for the compressed-air assisted atomization and application of a free-flowing coating material. The spray gun 1 can be configured, for example, as a so-called high-pressure, compliant or HVLP spray gun 1. The spray gun 1 has a cup connector 2 and a nozzle head 3 at which the coating material supplied to the spray gun 1 via the cup connector 2 is atomized and emerges in the form of a spray jet.

Furthermore, the spray gun 1 comprises a handle 4, a trigger 5 for actuating a material needle 10 disposed inside the spray gun 1, an adjustment mechanism 6 for the stroke of the material needle (material quantity regulation), an air pressure adjustment device 7 (micrometer), a round/broad jet adjusting device 8 and a compressed air connection 9. By means of the round/broad jet adjustment device 8, the distribution of the supplied compressed air as e.g. atomization and transport air on the one hand and horn air for a wide beam formation on the other hand, can be varied.

A flow cup 11 is connected to the cup connector 2 of the spray gun 1 by means of a material outlet configured as an outlet port 12. The flow cup 11 has a material container 13 on the base 14 of which the outlet port 12 is molded. Furthermore, the flow cup 11 comprises a screw cover 15 which closes the material container 13 and is provided with a ventilation device 16. The ventilation device 16 enables pressure equalization when coating material flows out of the flow cup 11 via the outlet port 12. Inside the material container 13 there is a sieve element 17 through which the coating material must pass before it can leave the material container 13 via the outlet port 12.

The outlet port 12 is equipped with connection means in the manner of a bayonet lock, which include a clamping wedge element 18 protruding radially from the outlet port 12. The clamping wedge element 18 engages in a corresponding receptacle groove 19 on the spray gun 1. The outlet port 12 seals axially e.g. by means of its end side 20 on the cup connector 2 and/or radially with the aid of two circumferential radial sealing lips 21 (hardly visible in FIG. 1 due to the proportions, see also FIG. 10).

The flow cup 11 according to FIG. 1 is embodied as a standard flow cup.

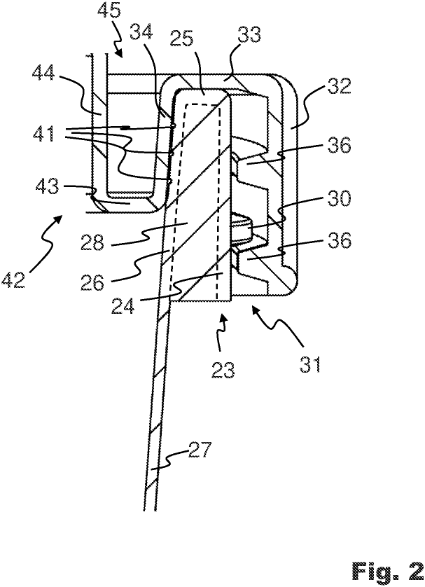

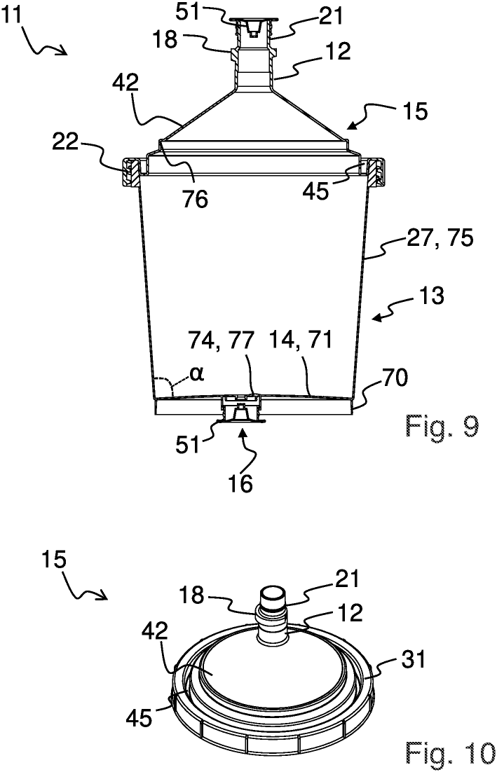

The screw connection 22 between the screw cover 15 and the material container 13 is described in detail below with reference to FIG. 2. The design of the screw connection 22 can be regarded as an independent subject matter of the invention, independently of the embodiment of the concave end wall. FIG. 2 shows an enlarged section of the flow cup 11 according to FIGS. 1 and 9 in the region of the connection point between the screw cover 15 and the material container 13.

The peripheral region of the material container 13 is provided with an eversion 23 which is reinforced by means of a plurality of radial transverse ribs 28. The transverse ribs 28 end almost flush with the outer edge of the eversion 23. The eversion 23 has an outer leg 24, a central connecting web 25 and an inner leg 26. The inner leg 26 transitions into a circumferential wall 27 of the material container 13. A section through a radial transverse rib 28, which is molded so as to be integral to the outer and the inner leg 24, 26 and the central connecting web 25, is shown in FIG. 2. The dashed lines in FIG. 2 indicate the profile of the outer leg 24 and the inner leg 26 and of the central connecting web 25.

Four threaded elements in the form of threaded webs 30 are provided on the outside of the outer leg 24 of the eversion 23. The threaded webs 30 are structurally identical to the threaded webs 30 shown in FIG. 12. FIG. 12 shows the material container 13 of a second exemplary embodiment of a flow cup 11, which will be described in more detail later, but whose screw connection 22 is of identical design and is therefore likewise shown in FIG. 2.

The peripheral region of the screw cover 15 has a receptacle groove 31 which is also formed by an outer leg 32, a central connecting web 33 and an inner leg 34. In the closed state of the flow cup 11, the receptacle groove 31 encompasses the eversion 23 in the peripheral region of the material container 13.

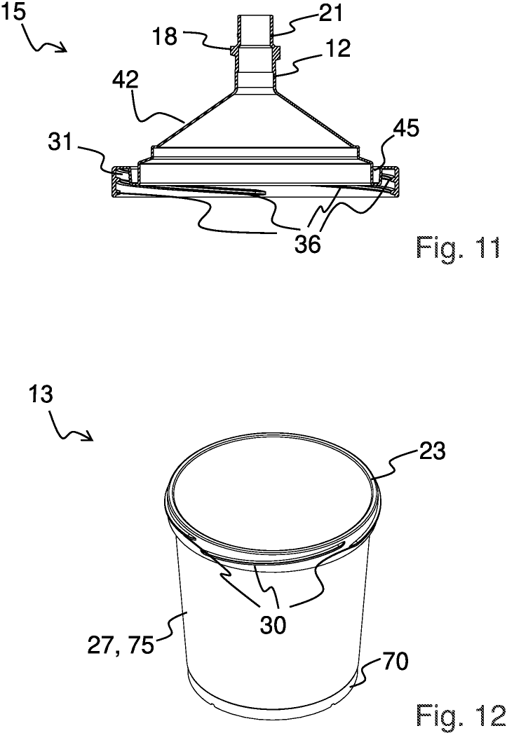

Inside the receptacle groove 31, more precisely on the inside of the outer leg 32, four threaded webs 36 are formed, which together with the threaded webs 30 on the material container 13 form the multi-threaded screw connection 22. All four threaded webs 36 begin approximately at the lower edge of the outer leg 32 and open into the central connecting web 33 which forms the base of the receptacle groove 31. The threaded webs 36 therefore partially overlap in the circumferential direction, but are axially offset from one another in the overlapping region. This can also be seen from FIG. 2, which shows two threaded webs 36 lying axially one above the other and overlapping in the circumferential direction. This can be seen even more clearly in FIG. 11, which shows a sectional view through the screw cover 15 of the second exemplary embodiment, in which the screw connection 22, as already mentioned, is of identical design.

The fluid-tight seal between screw cover 15 and material container 13 is achieved by a circumferentially sealing radial and axial contact inside the receptacle groove 31. Specifically, the radial sealing occurs between the outside of the inner leg 34 of the receptacle groove 31 and the inside of the inner leg 26 of the eversion 23 of the material container 13. The axial sealing takes place between the upper side of the central connecting web 33 of the eversion 23 and the base of the central connecting web 25 of the receptacle groove 31.

In an exemplary embodiment that is not shown, analogously to the exemplary embodiment according to FIG. 2, radial sealing can take place between the outside of the inner leg 34 of the receptacle groove 31 and the inside of the inner leg 26 of the eversion 23 of the material container 13, but instead of the additional axial sealing, no radial sealing (and supporting), or radial sealing (and supporting) between the inside of the outer leg 32 of the receptacle groove 31 and the outside of the outer leg 24 of the eversion 23 of the material container 13 may take place. The second radial sealing and, optionally supporting, can preferably take place near the corner region at the transition from the outer leg 24 to the central connecting web 25 of the eversion 23.

By way of example, three circumferential sealing ribs 41 are shown in FIG. 2, which are molded on the outside of the inner leg 34 of the receptacle groove 31 and lead to a further reinforcement of the sealing effect. Moreover, the sealing effect is improved by the fact that the inner diameter of the material container 13 in the upper peripheral region is selected in such a manner that the material container 13 is expanded when the screw cover 15 is installed, at least in the region of the eversion 23, thus resulting in a particularly strong and sustained radial compression between the screw cover 15 and material container 13 results.

It goes without saying that, as an alternative or in addition, further sealing ribs, lips, beads can also be formed at other points in order to increase the sealing effect. Alternatively, for example, only axial or only radial sealing between the screw cover 15 and the material container 13 can take place.

A central region 42 of the screw cover 15 is embodied as a continuation of the inner leg 34 of the receptacle groove 31. In FIG. 2 only an outer portion of the central region 42 of the screw cover 15 is shown. In particular, the inner leg 34 is followed by a first annular portion 43 of the central region 42 which extends at least almost perpendicularly to the receptacle groove 31. The annular portion 43 is followed by a second annular portion 44 of the central region 42 which runs at least almost parallel to the inner leg 34, specifically in such a manner that a compensating ring groove 45, which is open in the opposite direction to the receptacle groove 31, is formed. By means of the compensating ring groove 45 e.g. manufacturing tolerances of the components can be compensated, in particular to ensure the functionality, strength and tightness of the screw connection 22. In addition, a desired support or stiffness of the inner leg 34 can be defined via the dimensioning of the compensating ring groove 45.

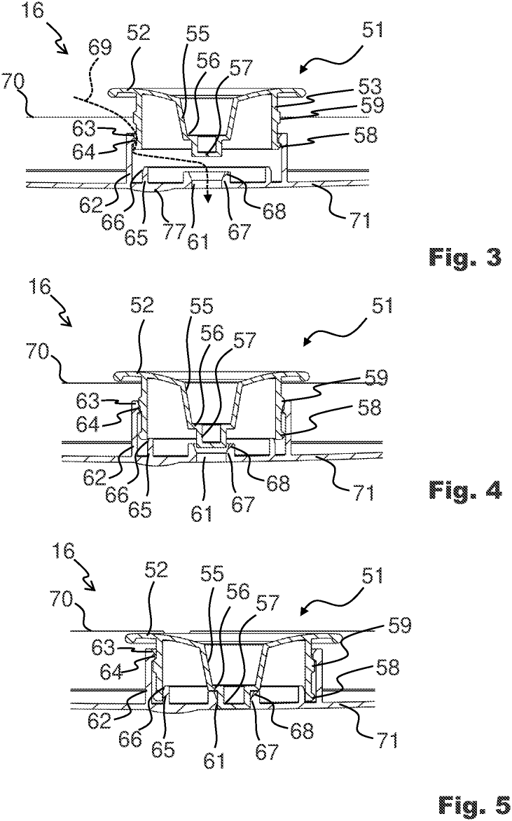

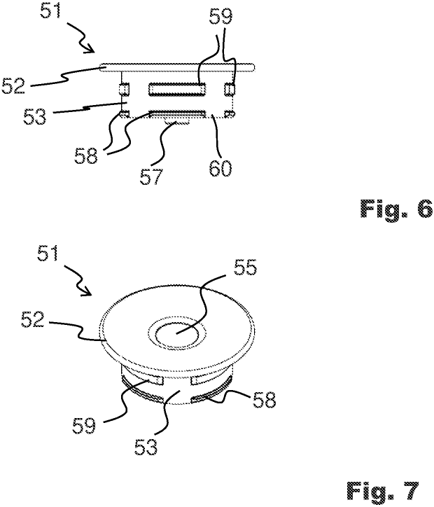

As can be seen from FIG. 1, the central region 42 of the screw cover 15 in the case of the exemplary embodiment according to FIG. 1 is provided with a ventilation device 16 which enables pressure equalization when coating material flows out of the flow cup 11 via the opposite outlet port 12. The construction of the ventilation device 16 will be explained in more detail hereunder by means of FIGS. 3 to 5, which show the ventilation device 16 in three different states, and FIGS. 6 and 7. The embodiment of the ventilation device 16 can be regarded as an independent subject matter of the invention, independently of the embodiment of the concave end wall.

The ventilation device 16 is embodied as a snap-in valve. It comprises a movable cap-shaped closure element 51 with a cap plate 52 from which a hollow collar 53 and a central hollow protuberance project. The hollow protuberance forms a hollow closure plug 55 which projects axially relative to the hollow collar 53 by a distance which corresponds at least almost to the wall thickness of the flow cup 11 in the region of the ventilation device 16 (see also FIG. 6).

The closure plug 55 is provided with an encircling shoulder 56 from which in turn an almost cylindrical plug tip 57 projects. The hollow collar 53 has first and second latching lugs 58, 59 which are axially offset relative to one another on the external circumference. The first and second latching lugs 58, 59 are spaced apart from one another in the circumferential direction, as a result of which air channels 60 are formed.

The construction of the closure element 51 is shown in particular in FIGS. 6 and 7, which show the closure element 51 in a side view and a perspective top view. The embodiment of the closure element 51 can be regarded as an independent subject matter of the invention, independently of the embodiment of the curved end wall.

On the outside of the flow cup 11, the ventilation device 16 has a ventilation opening 61 and three hollow collars disposed concentrically to the ventilation opening 61. The outer hollow collar 62 on the open end side thereof is provided on the internal circumference with an introduction chamfer 63 for the closure element 51 and a subsequent circumferential latching edge 64. The central hollow collar 65 forms a separate centering, retaining and guiding device. It is provided with a centering chamfer 66 on its outer circumference on its open end side. The inner hollow collar 67 forms the edge of the ventilation opening 61 and is provided with a centering chamfer 68 on its inner circumference on its open end side.

The outer hollow collar 62 projects in relation to the outside of the flow cup 11 by approximately three to four times the amount compared to the other two hollow collars 65, 67. The central hollow collar 65 projects in relation to the inner hollow collar 67 approximately by the amount by which the closure plug 55 projects in relation to the hollow collar 53 on the closure element 51.

To assemble the ventilation device 16, the closure element 51 is introduced into the outer hollow collar 62, this being facilitated by the introduction chamfer 63. The closure element 51 can be attached to the screw cover 15 or the material container 13 of the flow cup 11 separately from the flow cup 11, or by way of a tear-off tab, a web, or a film hinge and in this way made available to the user separately. The ventilation device 16 can also be pre-assembled in the factory and delivered to the user in working order.

In FIG. 3 the ventilation device 16 is illustrated in the maximum open position of the closure element 51. The first latching lugs 58 on the hollow collar 53, which is disposed on the closure element 51, engage behind the circumferential latching edge 64 on the outer hollow collar 62 on the outside of the flow cup 11. Due to the interaction of the first latching lugs 58 and the encircling latching edge 64, the closure element 51 is captively fastened to the flow cup 11. The frictional connection between the hollow collars 53, 62 prevents the closure element 51 from moving downwards from the maximum open position in FIG. 3 without an external force device or solely by the effect of gravity. Specifically, the first latching lugs 58 are embodied in such a manner that they are compressed radially with the internal circumferential face of the outer hollow collar 62. But it is also conceivable that further latching means, e.g. in the form of a second encircling latching edge, which counteract undesirable slipping and tilting of the closure element 51, are molded below the end-side latching edge 64.

In the maximum open position shown, there is a certain amount of play between the encircling latching edge 64 on the outer hollow collar 62 and the external circumferential face of the hollow collar 53, through which air can enter the flow cup 11. The flow path via which air from the outside gets into the interior of the flow cup 11 in order to ensure pressure equalization when coating material leaves the material container 13 via the outlet port 12 is sketched in FIG. 3 as a dashed arrow 69. After the inflowing air has passed the play, or the gap formed thereby, at the latching edge 64, said air flows between the first latching lugs 58 through the air channels 60 and finally through the ventilation opening 61 into the interior of the flow cup 11.

The constriction in the contact region of the outer hollow collar 62 and the hollow collar 53 has the advantage that even when the ventilation device 16 is in the open state, coating material is prevented from escaping if it sloshes or splashes out of the flow cup 11 through the ventilation opening 61 during the spraying process.

In addition, it is also conceivable that the encircling latching edge 64 is embodied with many smaller openings, i.e. is segmented, so that the incoming air can flow through these openings and not (only) through the gap formed by the play between latching edge 64 and the external circumferential face of hollow collar 53. In this case, play between the latching edge 64 and the external circumferential face of the hollow collar 53 can also be completely dispensed with and the two components bear in a matching fashion on the location.

The closure element 51 and in particular the cap plate 52 project significantly beyond an outer circumferential periphery 70 of the flow cup 11. An exemplary configuration of the circumferential periphery 70 can be seen in FIG. 1.

Thanks to the protrusion, a user can clearly see when the ventilation device 16 is in the open state. Moreover, when the flow cup 11 is placed on the circumferential periphery 70 with the side equipped with the ventilation device 16 facing down and a user has failed to close the ventilation device 16 beforehand, the closure element 51 is automatically pushed in the direction of the closed position by the surface on which the flow cup 11 is to be deposited. This prevents large quantities of the coating material from accidentally escaping. If a user places the (still) empty flow cup 11 with the ventilation device 16 open on the circumferential periphery 70, the flow cup 11 tilts back and forth due to the protruding cap plate 52, which advantageously draws the user’s attention to the ventilation device 16 that is still open before he/she fills in the coating material.

In order to close the ventilation device 16 in the usual way, a user presses on the cap plate 52, as a result of which the closure element 51 moves downwards in a straight line until it initially assumes the intermediate position according to FIG. 4. In the course of this first portion of the closing movement, the closure element 51 is guided by an interaction of the two hollow collars 53, 62. In particular, the closure element 51 is guided by the first latching lugs 58 sliding along the internal circumferential face of the outer hollow collar 62.

In the intermediate position according to FIG. 4, the second latching lugs 59 meet the latching edge 64 on the outer hollow collar 62. At least almost simultaneously, the end face of the hollow collar 53 impacts the centering chamfer 66 on the central hollow collar 65 and the plug tip 57 hits the centering chamfer 68 on the inner hollow collar 67. The meeting at the three different points results in a precise and functionally reliable centering of the closure element 51 and in particular of the closure plug 55 before the closure plug 55 penetrates the ventilation opening 61 during the further closing movement.

The last part of the closing movement follows, in which the closure element 51 is transferred from the intermediate position shown in FIG. 4 to the closed position shown in FIG. 5. In this portion of the movement, the closure element 51 is additionally guided by an interaction of the hollow collar 53 and the central hollow collar 65. Specifically, the internal circumferential face of the concave collar 53 slides along the external circumferential face of the central hollow collar 65. In this very delicate portion of the movement, the closure element 51 is guided in a very robust and stable manner.

In FIG. 5 the closure element 51 assumes the closed end position. The closure plug 55 closes the ventilation opening 61. Said closure plug 55 is in sealing contact with the internal circumferential face of the opening 61. In this state, neither air can flow into the flow cup 11 via the ventilation device 16, nor can coating material escape from the flow cup 11 via the ventilation device 16.

The fact that the end side of the hollow collar 53 is disposed or enclosed in an annular space between the outer hollow collar 62 and the central hollow collar 65 also results in a type of labyrinth restraint device. As a result, in particular, coating material is held back that has entered the space between the inner and central hollow collars 67, 65 before the ventilation device 16 is closed, thus preventing it from getting out into the environment.

In particular, the internal circumferential face of the hollow collar 53 can also lie tightly in an encircling manner against the external circumferential face of the central hollow collar 65 so that an escape of coating material is counteracted even more effectively.

It can be seen from FIG. 5 that the shoulder 56 on the closure plug 55 rests on the end side of the inner hollow collar 67 in the closed end position, as a result of which the axial position of the closure element 51 in the closed end position is defined. The defined axial stop ensures that the closure plug 55 does not penetrate too far into the interior of the flow cup 11 and does not project inward relative to the end wall 71.

Furthermore, it can be seen from FIG. 5 that the cap plate 52 is now set back from the circumferential periphery 70. The closure element 51 is held in a functionally reliable manner in the closed end position by an interaction of the second latching lugs 59 on the hollow collar 53 and the encircling latching edge 64 on the outer hollow collar 62.

In order to open the ventilation device 16 again, a user can grip the closure element 51 on the cap plate 52 and pull it upwards back into the maximum open position according to FIG. 3.

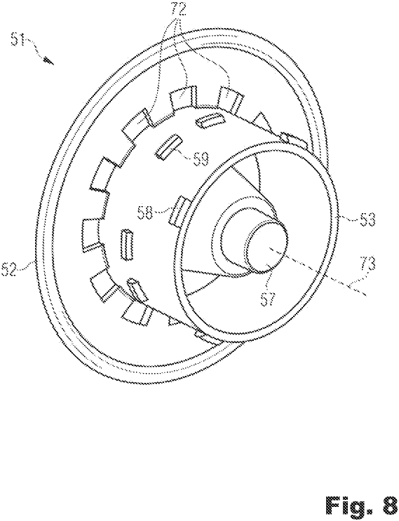

Shown in FIG. 8 is an alternative second embodiment of a closure element 51, which largely corresponds to the first embodiment, so that identical and similar components are given the same reference numbers. The second embodiment of the closure element 51 can also be regarded as an independent subject matter of the invention, independently of the embodiment of the curved end wall. The second exemplary embodiment differs only in that the first and second latching lugs 58, 59 are disposed so as to be mutually offset not only axially but also in the circumferential direction. Each latching lug 58, 59 is assigned a cut-out 72 which in the cap plate 52 lies above the former. Thanks to these measures, the closure element 51 can be produced without forced demolding using a simple two-part injection-molding tool, the tool parts of which are converged and diverged along the longitudinal axis 73 of the closure plug 55.

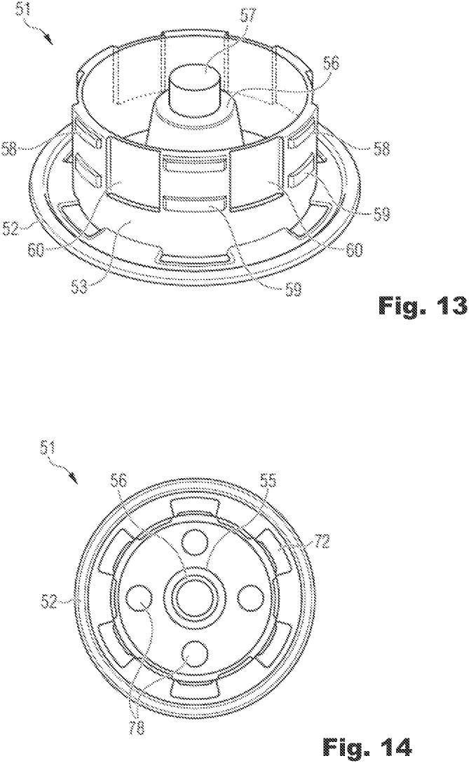

Shown in FIGS. 13 and 14 is an alternative third embodiment of a closure element 51, which largely corresponds to the first and second embodiment, so that identical and similar components are denoted by the same reference numbers. The third embodiment of the closure element 51 can also be regarded as an independent subject matter of the invention, independently of the embodiment of the rest of the ventilation device 16. The third exemplary embodiment in comparison to the other exemplary embodiments is distinguished in that six pocket-shaped recesses are formed by reducing the wall thickness in the circumferential direction between the six portions with the latching lugs 58, 59, which serve as air ducts 60, or lead to an enlargement of the air ducts 60, when the closure element 51 is disposed in the maximum open position on the flow cup 11. Furthermore, the stiffness of the hollow collar 53 is specifically adjusted by the pocket-shaped recesses.

The cap plate 52 of the closure element 51 has a plurality of cut-outs 72 like the exemplary embodiment according to FIG. 8. A cut-out 72 in the cap plate 52 is assigned to each latching lug 59. Thanks to these measures, the latching lugs 59, which are particularly important for functionally reliable holding of the closure element 51 in the closed position, can be produced without forced demolding and the use of specific tools, with the aid of a simple two-part injection molding tool, the tool parts of which are converged and diverged along the longitudinal axis 73 of the closure plug 55. By contrast, the latching lugs 58, which are disposed offset only axially but not in the circumferential direction with respect to the latching lugs 59, are produced by forced demolding. Four circular imprints are visible on the cap plate 52, which originate from the ejectors of the injection-molding tool for producing the closure element 51.

It can be seen from FIGS. 1 and 9 that the ventilation device 16 is disposed on the outside of the end wall 71 of the flow cup 11, which is provided with a a concavity which extends evenly over the end wall 71. In particular, there is a concave curvature toward the interior of the material container 13.

The location 74 of the concave end wall 71, which protrudes furthest inward due to the concavity, has an offset or a depth of 1% to 4%, more precisely 2% to 3% of the diameter of the end wall 71, compared to the outer peripheral region of the end wall 71. In the embodiment shown, the diameter is e.g. d = 84.6 mm and the (height) offset is V = 2.0 mm, e.g.

A circumferential wall 75 of the flow cup 11 borders on the concave end wall 71. The circumferential wall 75 is closed by the concave end wall 71. The circumferential wall 75 is conical to such an extent that the concave end wall 71 (despite the concavity) adjoins the circumferential wall 75 at an angle of more than 90°. In the exemplary embodiments shown, an angle α of approximately 92° results.

Due to the proportions in FIG. 1, this can hardly be seen. For a better understanding, reference is therefore made to the exemplary embodiment shown in FIG. 9. The second embodiment is explained in more detail below.

The exemplary embodiment of a flow cup 11 according to the invention shown in FIG. 9 and FIGS. 10 to 12 largely corresponds to the first exemplary embodiment, so that the same reference numbers are used for identical or similar components.

Overall, the flow cup 11 according to the second embodiment is embodied as an upside-down flow cup.

The flow cup 11 likewise has a screw cover 15 and a material container 13 which can be closed in a fluid-tight manner by means of the screw cover 15. In contrast to the first exemplary embodiment, the outlet port 12 is disposed on the screw cover 15 and the ventilation device 16 is disposed on the base of the material container 13. A sieve element receptacle 76 for a flat, disk-shaped sieve element (not shown) is provided in the screw cover 15, analogously to the sieve element 17 shown in FIG. 1. As an alternative to a flat sieve element, a cylindrical plug-in sieve can be used, which can be fixed in the outlet port 12 or in the cup connector 2 on the spray gun side. This also applies to the first exemplary embodiment according to FIG. 1.

The connection means, by means of which the outlet port 12 can be assembled on a spray gun 1, correspond to the connection means on the outlet port 12 of the first exemplary embodiment, so that reference is made to the corresponding passages in the description of the figures.

The screw connection 22, the ventilation device 16 including the concave end wall 71 on which the ventilation device 16 is disposed, in terms of construction and function correspond to that of the first exemplary embodiment of a flow cup 11, so that reference is also made to the relevant passages.

It is clear from FIGS. 9 to 12 that the concave end wall 71 forms the base 14 of the cup-shaped material container 13. In the exemplary embodiment shown, the end wall 71 is produced in one piece with the circumferential wall 75 and the circumferential periphery 70 of the material container 13. Thanks to the conical embodiment of the circumferential wall 75 of the material container 13 and the concavity of the end wall 71 forming the base 14, a plurality of material containers 13 can be stacked closely one inside the other.

It can be seen from FIG. 9, which shows a sectional view of the entire flow cup 11, that the closure element 51 of the ventilation device 16 can also serve as a closure element 51 for the outlet port 12. The same also applies to the outlet port 12 of the first exemplary embodiment.

In FIG. 10, which shows a perspective top view of the screw cover 15 without the closure element 51 on the outlet port 12, the compensating ring groove 45, which follows the receptacle groove 31 in the screw cover 15, and the connection and sealing means on the outlet port 12 in the form of the clamping wedge element 18 and the radial sealing lips 21 are clearly visible.

FIGS. 11 and 12 serve in particular to illustrate the configuration of the threaded webs 30, 36 of the screw connection 22 between the screw cover 15 and the material container 13. As already explained, this is a multi-threaded screw connection 22. Four threaded webs 30, 36 are formed on both the cover and the container. The threaded webs 36 on the cover are disposed in the receptacle groove 31 and each run from the lower edge of the receptacle groove 31 to the base of the receptacle groove 31. The cover-proximal threaded webs 36 therefore partially overlap in the circumferential direction. The container-proximal threaded webs 30, on the other hand, do not overlap in the circumferential direction.

The flow cups 11 according to the first and second exemplary embodiment are preferably made of plastic in a plastics injection-molding process, with the screw cover 15 and the material container 13 being integrally molded, apart from the closure element 51 and the sieve elements 17.

In the case of an exemplary embodiment that is not shown, one or a plurality of closure elements 51 and/or one or a plurality of sieve elements 17 can also be produced so as to be integral with the screw cover 15 or the material container 13. For example, they can be attached to any location by tear-off webs, tabs, film hinges, etc., which can be severed in order to assemble the elements elsewhere.

The material containers 13 are made of polypropylene (PP), for example, and the screw covers 15 are produced from, for example, hard polyethylene (HDPE) or polypropylene (PP). The closure element 51 is also manufactured from, for example High Density Polyethylene (HDPE) or polypropylene (PP).

The flow cups 11 according to the invention are preferably extremely thin-walled products. The wall thickness of the material container 13 is in the range from 0.55 mm to 0.65 mm, specifically 0.60 mm, and the wall thickness of the screw cover 15 is in the range from 0.75 mm to 0.85 mm, specifically 0.80 mm. The only exceptions are accumulations of material at local spots, e.g. for the formation of thread flanks, latching and gripping edges or on the outlet port, in particular for the formation of the clamping wedge element 18.

The screw cover 15 of the first exemplary embodiment and the material container 13 of the second exemplary embodiment are preferably produced in an injection-molding method in which the injection point of the components is located as centrally as possible on the concave end wall 71. In order to make this possible, the ventilation device 16 is disposed slightly off-center. Said ventilation device 16 is disposed with an offset of more than 5% but less than 10% of the diameter of the end wall 71 towards the center of the end wall 71.

In FIG. 3, the injection point 77, which also corresponds to the location 74 (FIGS. 1 and 9, maximum concavity), can be seen to the left of the ventilation opening 61 owing to a smaller accumulation of material. In the exemplary embodiment shown, the offset between the eccentric ventilation opening 61 and the central injection point 77 is 5.50 mm; given a diameter of the end wall 71 of 84.6 mm, this corresponds to 6.50%.

The flow cup 11 according to the invention and the spray gun 1 equipped therewith are suitable for atomizing and applying very dissimilar materials. A main field of application is automotive repair paintwork, in which top coat, filler and clear coat are used and which places very high demands on the atomization and the properties of the spray jet. However, a large number of other materials can also be processed using the flow cup 11 and a potentially modified spray gun 1. The decisive factor is that the materials are free-flowing and can be sprayed, at least to a certain extent.

1-10. (canceled)

11. A flow cup for a spray gun, which has a material outlet which is embodied for direct and/or indirect connection to a spray gun, the flow cup having a material container which on at least one end side is closed by a disk-shaped end wall, a ventilation device by way of which air can flow into the flow cup to enable pressure equalization when material flows out of the flow cup by way of the material outlet being disposed on the outside of the end wall, wherein the end wall is provided with a concavity which extends uniformly across the end wall.

12. The flow cup as claimed in claim 11, wherein the location of the concave end wall which protrudes furthest inwards due to the concavity, has an offset relative to an outer peripheral region of the end wall.

13. The flow cup as claimed in claim 11, wherein the ventilation device comprises an off-center ventilation opening through the concave end wall, which is disposed with an offset relative to the center of the end wall.

14. The flow cup as claimed in claim 11, wherein the concave end wall adjoins a circumferential wall of the flow cup at an angle of more than 90°.

15. The flow cup as claimed in claim 11, wherein a circumferential wall of the flow cup, proceeding from the end side that is closed by the concave end wall, widens conically.

16. The flow cup as claimed in claim 11, wherein a circumferential periphery is provided which projects outward in relation to the concave end wall.

17. The flow cup as claimed in claim 11, wherein the ventilation device comprises a closure element which can be moved between at least one open position in which air can flow into the flow cup and a closed position in which no air can flow through the ventilation device into the flow cup.

18. The flow cup as claimed in claim 11, wherein a movable closure element of the ventilation device, in a closed position in which no air can flow through the ventilation device into the flow cup, is set back in relation to a circumferential periphery.

19. The flow cup as claimed in claim 11, wherein a movable closure element of the ventilation device in an open position, in which air can flow through the ventilation device into the flow cup, projects in relation to a circumferential periphery.

20. The flow cup as claimed in claim 11, wherein the concave end wall is releasably connected to the material container.

21. The flow cup as claimed in claim 11, wherein the concavity of the end wall is a concave curvature toward the inside of the material container.

22. The flow cup as claimed in claim 12, wherein the offset relative to the outer peripheral region of the end wall has a depth of 1% to 4% of the diameter of the end wall.

23. The flow cup as claimed in claim 13, wherein the offset relative to the center of the end wall is more than 5% and less than 10% of the diameter of the end wall.

24. The flow cup as claimed in claim 15, wherein the circumferential wall of the flow cup widens conically such that the concave end wall adjoins the circumferential wall at an angle of more than 90°.

25. The flow cup as claimed in claim 11, wherein the concave end wall, is part of a cover of the flow cup and is releasably connected to the material container.
